(19) United States
(12) Patent Application Publication
(10) Pub. No.: US 2017/0155560 A1
(43) Pub. Date: Jun. 1, 2017

(54) MANAGEMENT SYSTEMS FOR MANAGING RESOURCES OF SERVERS AND MANAGEMENT METHODS THEREOF

(71) Applicant: Quanta Computer Inc., Taoyuan City (TW)

(72) Inventors: En-Chi LEE, Taoyuan City (TW); Chun-Hung CHEN, Taoyuan City (TW); Chien-Kuo HUNG, Taoyuan City (TW); Wen-Kuang CHEN, Taoyuan City (TW); Tien-Chin FANG, Taoyuan City (TW); Chen-Chung LEE, Taoyuan City (TW)

(21) Appl. No.: 15/075,541

(22) Filed: Mar. 21, 2016

(30) Foreign Application Priority Data
Dec. 1, 2015 (TW) 104140049

(51) Int. Cl. H04L 12/24; H04L 12/911; H04L 12/26

(52) U.S. Cl. CPC H04L 41/5009; H04L 43/0817; H04L 47/70

(57) ABSTRACT

A management method for management of resources of servers is provided, the method including the step of: collecting, by a resource status monitor, performance monitoring data of each resource within each of the servers and operation status data of a plurality of virtual machines within the servers; analyzing, by an abnormality analysis and determination device, the performance monitoring data and the operation status data collected to automatically send a trigger signal in response to determining that a virtual machine in performance abnormal status is exist among the virtual machines; and automatically performing, by a resource allocator, a processing on the virtual machine in performance abnormal status in response to the trigger signal, wherein the processing is at least one action of a limiting processing, a transfer processing and a resource allocation.

### CROSS REFERENCE TO RELATED APPLICATIONS

100011 This Application claims priority of Taiwan Application No. 104140049, filed on Dec. 1, 2015, and the entirety of which is incorporated by reference herein.

### BACKGROUND OF THE INVENTION

Field of the Invention

The invention relates to resource management systems and methods, and more precisely, to management systems and methods for management of resources of servers and systems capable of managing multiple servers and virtual machines.

Description of the Related Art

In recent years, with the rapid progress of science and technology, virtualization technology for computer systems has become more and more popular. As virtualization technology has become one of the mainstream of the Infrastructure as a Service (IaaS) technology, various manufacturers provides uninterrupted renting services to achieve the goal for high service level agreements (SLA). To ensure service operates normal, most service providers may install monitoring software on the room, in addition to monitoring the performance of the monitoring operation is normal, or even to predict the occurrence of abnormal situations and remedies may be made for the first time before a problem occurs. Monitoring range for monitoring software comprises hardware and software performance monitoring, equipment malfunction surveillance, data security or the like. Monitoring items can be divided into single item monitoring and multi-items monitoring. Single monitoring software may have its focus on a single item, such as focus on monitoring network traffic and packet analysis, or on monitoring and maintenance of the storage equipment with a SAS interface. Multi-items monitoring provides a common performance monitoring, such as monitoring on virtual machine CPU, memory and hard disk read and write performance.

Generally, free monitoring software is widely used due to cost reduction consideration and because the high cost and enterprise monitoring purpose vary for the integrated monitoring software, most companies use only a part of the monitoring items, thereby lowering integration monitoring benefits. Moreover, if the use of multiple sets of free monitoring software can meet basic monitoring needs, it might tend to take the free monitoring software. In addition, a number of sets of monitoring software may be installed to ensure that the overall operation functioning properly. This software, however, in addition to serve as backup equipment for each other equipment, but also provide more detailed monitoring information. Therefore, the integration between the different monitoring software has become an issue necessary to be resolved. A manager must install multiple sets of monitoring software and then open the multiple sets of monitoring software to view and monitor information with time, thereby causing the manager to spend a lot of time and effort on monitoring. In addition, many free monitoring software provide powerful monitoring capabilities, but lack of an alarm or it may require additional modules with the active alarm function to be installed to active alarm function, such that the manager was unable to detect abnormalities in time and perform subsequent emergency treatment, often resulting in time delays of abnormal handling.

### BRIEF SUMMARY OF THE INVENTION

One embodiment of the invention provides a management method for management of resources of servers, the method including the step of: collecting, by a resource status monitor, performance monitoring data of each resource within each of the servers and operation status data of a plurality of virtual machines within the servers; analyzing, by an abnormality analysis and determination device, the performance monitoring data and the operation status data collected to automatically send a trigger signal in response to determining that a virtual machine in performance abnormal status is exist among the virtual machines; and automatically performing, by a resource allocator, a processing on the virtual machine in performance abnormal status in response to the trigger signal, wherein the processing is at least one action of a limiting processing, a transfer processing and a resource allocation.

Another embodiment of the present invention provides a management system for management of resources of servers, comprising a plurality of servers, a plurality of virtual machines and a management device. The virtual machines are separately configured on the servers. The management device is coupled to the servers through a network, including a resource status monitor, an abnormality analysis and determination device and a resource allocator. The resource status monitor is coupled to the servers for collecting performance monitoring data of each resource within each of the servers and operation status data of the virtual machines within the servers. The abnormality analysis and determination device is coupled to the resource status monitor for analyzing the performance monitoring data and the operation status data collected to determine whether a virtual machine in performance abnormal status is exist among the virtual machines and automatically send a trigger signal in response to determining that the virtual machine in performance abnormal status is exist. The resource allocator is coupled to the abnormality analysis and determination device for automatically performing a processing on the virtual machine in performance abnormal status in response to the trigger signal, wherein the processing is at least one action of a limiting processing, a transfer processing and a resource allocation.

Management methods for management of resources of servers may be practiced by the disclosed apparatuses or systems which are suitable firmware or hardware components capable of performing specific functions. Image processing methods may also take the form of a program code embodied in a tangible media. When the program code is loaded into and executed by an electronic device, a processor, a computer or a machine, the electronic device, the processor, the computer or the machine becomes an apparatus for practicing the disclosed method

### BRIEF DESCRIPTION OF THE DRAWINGS

The invention can be more fully understood by reading the subsequent detailed description and examples with reference to the accompanying drawings, wherein:

FIG. 1 is a schematic diagram illustrating an embodiment of a management system for management of resources of servers of the invention;

FIG. 2 is a flow chart illustrating a management method for management of resources of servers according to an embodiment of the invention; and

FIG. 3 is a schematic diagram illustrating an embodiment of resource partitions of the invention;

FIG. 4 is a schematic diagram illustrating an embodiment of the transfer processing of the invention; and

FIGS. 5A and 5B are flow charts illustrating a management method for management of resources of servers according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Embodiments of the invention provide management systems and related methods for management of resources of servers, which can automatically collect a verity of data of servers and virtual machines through monitoring and processing and can automatically completed subsequent automated processing, such as limiting processing, transfer processing and so on, in accordance with the running services of the virtual machines and virtual partitions along with the weights of resources being operated as the basis when there is an abnormal situation, thereby reducing human error to exclude or delay the time of processing and achieving a goal for effective management and efficiently reducing the impact of the loss caused by the delay during processing.

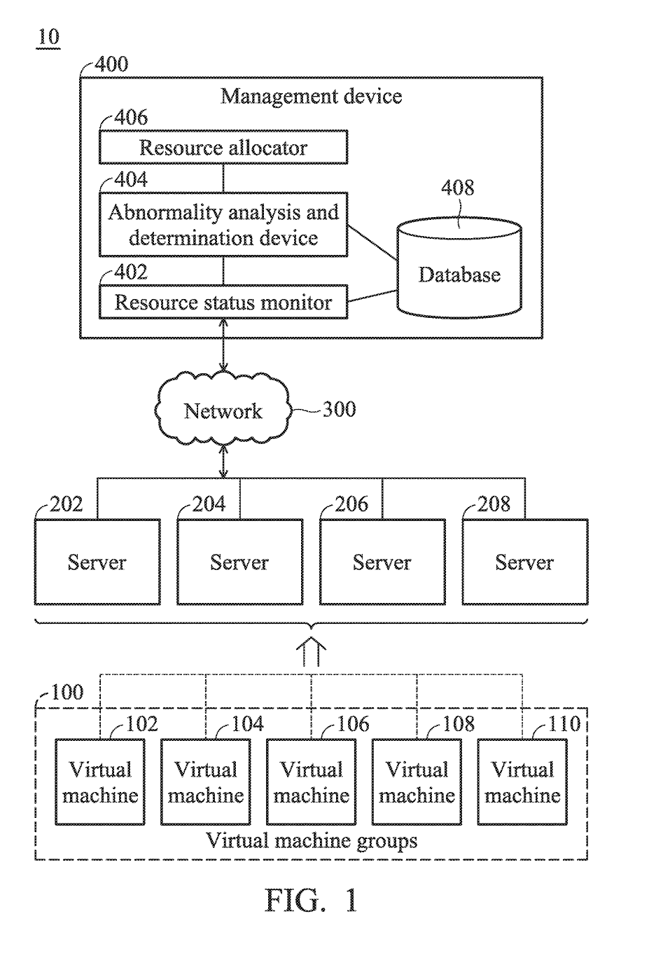

FIG. 1 is a schematic diagram illustrating an embodiment of a management system 10 for management of resources of servers of the invention. As shown in FIG. 1, the management system 10 for management of resources of servers (hereinafter referred to as the management system 10) includes at least one virtual machine group 100, a plurality of server 202, 204, 206 and 208 and a management device 400. The virtual machine group 100 includes a plurality of virtual machines 102,104,106,108 and 110, wherein each virtual machine may perform one to a number of operating programs or applications to run or to provide specific services. Among them, the virtual machine 102,104,106,108 and 110 are arranged in the servers 202, 204 and 208 and each server may have one or more virtual machines correspond thereto. For example, in one embodiment, the virtual machine 102 can be configured on the server 202, the virtual machine 104 can be configured on the server 204, the virtual machine 106 can be configured on the server 206, and the virtual machines 108 and 110 can be configured on the server 210. However, it should be understood that the invention is not limited thereto. Specifically, that the virtual machine 102 is configured on the server 202 represents that the virtual machine 102 activates on the server 202 and uses the system resources on the server 202, such as processor, memory and others to run specified services or applications. The server 202. 204, 206, and 208 may through a physical network 300, such as a wired network, such as the Internet, and/or a wireless network, such as WCDMA network, 3G network, Wireless Local Area Network (WLAN), Bluetooth or other wireless network to connect to the management device 400 for performing wireless communications and data transmission between each other.

The management device 400 may be used to manage the servers 202, 204, 206 and 208 through the network 300, including collecting a verity of performance monitoring data and running status of each virtual machine within each server and information regarding the location of each virtual machine allocated and so on. For example, the performance monitoring data may include monitoring performance of hardware and software, monitoring of equipment abnormality or data security such as virtual machine CPU, memory and hard disk read and write performance and other performances, and the running status of the virtual machine is used to represent the operating status of the virtual machine. The performance monitoring data and the running status of the virtual machine and distribution details will be described further in the following paragraphs. The management device 400 includes at least one resource status monitor 402, an abnormality analysis and determination device 404, a resource allocator 406 and a database 408. The resource status monitor 402 is coupled to the virtual machines 102-110, which can collect all the necessary information within all of the servers 202-208 and 102-110 and all of the virtual machines 102-110. The abnormality analysis and determination device 404 is coupled to the resource status monitor 402, which can be used to analyze the information collected by the resource status monitor 402 and perform abnormality determination. The resource allocator 406 is coupled to the abnormality analysis and determination device 404, which can automatically perform dedicated subsequent processing on a virtual machine in performance abnormal status when the abnormality analysis and determination device 404 determines that there is an abnormal situation. The database 408 may be used to store related data, such as resource items information to be monitored, product knowledge information and abnormality determination rule data including definition data of abnormality trigger conditions, to provide guidelines in a data collection and abnormality determination for the abnormality analysis and determination device 404 to determine according to the running state data collected and performance monitoring data to determine whether there is a virtual machine in performance abnormal status among the virtual machines based on the collected operation status data and performance monitoring data. Specifically, the management device 400 can control operations of the resource status monitor 402, the abnormality analysis and determination device 404 and the resource allocator 406 to the management method for management of resources of servers of the present invention, which will be discussed further in the following paragraphs.

However it should be understood by those skilled in the art that the invention is not limited thereto. For example, the management system 10 can also include a plurality of virtual machine groups, wherein each group can have resource status monitors corresponding thereto and a plurality of virtual machines and the management device can also be provided in one of the servers 202-208 or be configured on another separate server. In addition, the number of servers and the number of virtual machines may also be adjusted based on actual requirement and architecture. It should be understood by those skilled in the art that the management apparatus 400, the resource status monitor 402, the abnormality analysis and determination device 404 and the resource allocator 406 and other components of the invention may have sufficient hardware circuits, components and/or with the software, firmware, and combination thereof to achieve the desired functionalities.

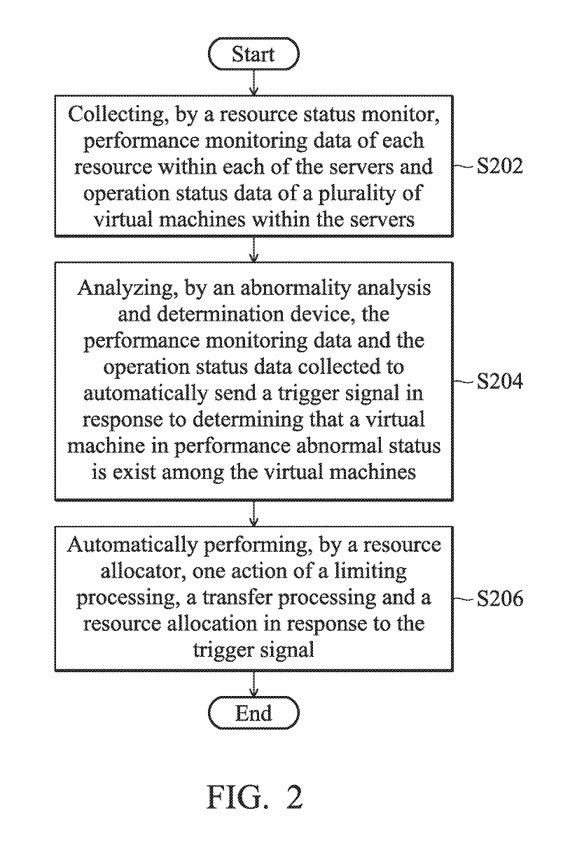

FIG. 2 is a flowchart of an embodiment of a management method for management of resources of servers of the invention. Please refer to FIGS. 1 and 2. The management method for management of resources of servers can be applied to the management system 10 as shown in FIG. 1, which can remotely manage all of the servers and virtual machines via the network 300.

In step S202, the resource status monitor 402 periodically collects performance monitoring data of each resource within each server and operating status data of a plurality of virtual machines within the servers. For example, the resource status monitor 402 may provide basic monitoring on performance of each resource and operation status of each virtual machines within each server, such as the virtual machine CPU usage, memory usage pressure, disk read/write data per second and network sent/received data per second, and the memory usage monitoring of specific application, such as MySQL DB's memory usage, etc., stored in the database 408 after obtaining the information through the resource control mechanism to complete the monitoring data collection. In one embodiment, the database 408 may have monitoring data stored in advance, in order to define the items and statuses to be monitored, and the resource status monitor 402 may collect the performance monitoring data of each resource within each server and operation status data of each virtual machine within the servers according to the stored monitoring data. In another embodiment, in order to ensure the monitoring software and the monitored items its supported can be expanded elastically, the present invention also provides an expansion way of importing product knowledge program library to provide monitoring data. Through importation of simple operation management components, the monitoring software's monitored items, monitored targets and values units, such as virtual machine heartbeat rate monitored, network abnormal packets, CPU temperature detection data and other information can be provided to the resource status monitor 402 so that the resource status monitor may collect the monitored items in the management system 10 according to imported monitoring information.

In step S204, the abnormality analysis and determination device 404 analyzes the performance monitoring data and the operation status data collected to determine whether or not a virtual machine in performance abnormal status is exist among the virtual machines, and in response to determine that the virtual machine in performance abnormal status is exist, automatically sends a trigger signal. Specifically, the database 408 may pre-set the definition data of adjustment setting, and the abnormality analysis and determination device 404 may obtain abnormality trigger conditions according to the definition data of adjustment setting to adjust abnormality determination. The definition data of adjustment setting was used to define the trigger conditions of abnormal events, wherein each monitored item may have a trigger condition configured, such as setting a upper limit for basic performance of the virtual machine being monitored, e.g., the virtual machine CPU usage, memory usage pressure, disk read/write data per second and network sent/received data per second. When an item is found to reach the upper limit, it would mean an abnormal situation occurs. For example, a number of Mbps for the network traffic sent by the virtual machine and a time period to indicate that too much server traffic will be occupied to led to services of other virtual machines be interrupted when the network traffic sent by the virtual machine has exceeded the number of Mbps and has continued more than the time period (e.g., a few minutes). In such case, it is determined that the performance abnormal event occurs. In one embodiment, it is assumed that the performance monitoring data includes overall and CPU temperature of each server, hard disk space and a healthy state, when a server's CPU temperature is higher than an upper limit degree (e.g., more than 50 degrees) or the hard disk health status is abnormal (e.g., the number of bad tracks for the hard disk overs 10), it is determined as abnormal, then the abnormality analysis and determination device 404 may identify that this server shall be repaired rather than running any virtual machine. When the resources of a virtual machine is not enough to be used or any of trigger conditions has been met, the abnormality analysis and determination device 404 may determine that it is the virtual machine in performance abnormal status, and automatically send a trigger signal in response to determine that the virtual machine in performance abnormal status is exist. This trigger signal is sent to the resource allocator 406.

When receiving the trigger signal 404 issued from the abnormality analysis and determination device 404, in step S206, the resource allocator 406 automatically performs at least one action of a limit processing, a transfer processing and a resource allocation in response to the trigger signal. Specifically, the resource allocator 406 can provide proactive alerting and virtual machine transfer mechanism based on the conditions for triggering resource allocation pre-defined by the manager, in accordance with current resources and server performance with resource use weights concept for perform subsequent processing. That is, the limiting processing, the transfer processing, the resource allocation and other actions are selectively performed to complete the automated adjustment of resources. Among them, the limiting processing limits the resources of the virtual machine in performance abnormal status, the transfer processing moves the virtual machine in performance abnormal status to a transfer server for operation, and the resource allocation reallocates resources of the virtual machine in performance abnormal status.

For limiting processing, the resource allocator 406 automatically determines the type of virtual machine in performance abnormal status and performs the resource limiting to set an upper limit of the use of resources according to its type. For example, if the virtual machine belongs to a machine with a traffic restriction capability, when an abnormal event occurs, the upper and lower limits for the traffic can be set, such as setting input/output operations per second (IOPS) for the hard disk and setting quality of service parameters (QoS) for the network traffic, to limit the upper limit of the traffic to ensure that other virtual machines run on the same server will not be affected. Note that TOPS represents the measurement mode of performance testing for computer storage devices (such as a hard disk (HDD), solid-state drives (SSD) or storage area network (SAN)), in unit of read and write times per second.

In one embodiment, the resource allocator 406 performs the transfer processing is to find a transfer server (e.g., the server 204) other than the server (e.g., the server 202) that the virtual machine in performance abnormal status located and transfer the virtual machine in performance abnormal status to the transfer server for operation. Specifically, the resource allocator 406 continually detects abnormal items indicated by the trigger signal and determines an abnormal is occurred when the abnormal items occur continually, e.g., when the virtual machine continually faces unexpected occurrence such as CPU usage lasting more than 80 percent, to automatically trigger the transfer mechanism to determine that the running service of the virtual machine and based on the needs of the computing resources of the virtual machine to find out the optimal transfer server from the rest of the servers to ensure operational effectiveness.

In one embodiment, the resource allocator 406 performs the resource allocation on the server that the virtual machine in performance abnormal status located. For example, assume that the virtual machine in performance abnormal status is running on the server 202, the resource allocator 406 can reallocate operation resources of other virtual machines on the server 202 to the virtual machine in performance abnormal status, so that the virtual machine in performance abnormal status may regain enough resources.

In some embodiments, in order to obtain a balance between the virtual machine operating performance and the number of virtual machines, the present invention further provides management mechanism based on resource partitions setting. The management mechanism based on resource partitions setting comprises establishing a number of resource partitions according to demand for the use of resources and then individually set different trigger conditions for each resource partition. The resource allocator 406 can refer to the resource partition setting management and based on the weight and performance requirements of resources to establish a plurality of resource partitions and perform the aforementioned processing based on information of the resource partition that the virtual machine in performance abnormal status located. The resource partition information can record information regarding the resource partition located for each virtual machine for each virtual machine in the resource partition.

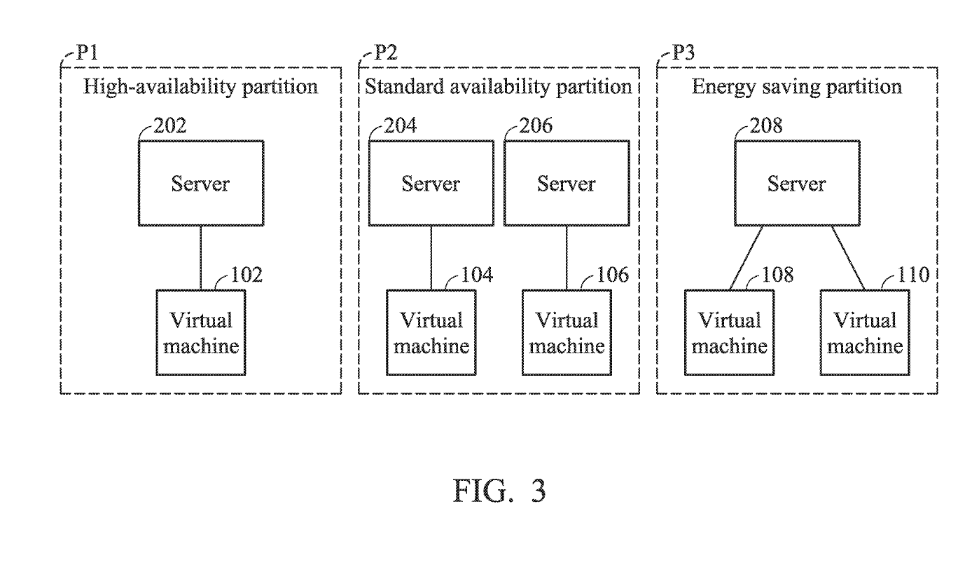

For example, refer to FIG. 3, which is a schematic diagram illustrating an embodiment of resource partitions of the invention. As FIG. 3, the resource partitions can be divided into a high-availability resource partition P1, a standard availability resource partition P2 and an energy saving partition P3, wherein the server 202 and the virtual machine 102 are allocated in the high-availability resource partition P1, the servers 204 and 206 and the virtual machines 104 and 106 are allocated in the standard availability resource partition P2, and the server 208 and the virtual machines 108 and 110 are allocated in energy saving partition P3. Each partition P1-P3 has a different set of resources adjustment setting, which may adjust the setting of upper and lower limits of resources, such as network I/O read no more than 10 GB, etc., and each resource partition has a different tolerance range of definition data for abnormal event triggering. For example, the high availability resource region P1 can be used to provide a general virtual machine running, in which its hard disk using a cluster set configuration, and requires resources (for example: CPU, memory and network read/write traffic) more on average, but resource requirements for CPU and memory will be better than the hard disk I/O performance. In addition, if a virtual machine running the Internet-related services, it specially requests the network I/O, such as running webpage, DHCP or Active Directory (AD) domain services, so data adjustment for this kind of servers can't be focused on a same server, and the virtual machine running on the server can't be too much.

The hard disk for the server in the standard availability resource partition P2 does not use a cluster set configuration. Each server runs independently from each other, so the server's hard disk I/O will not affect each other, which is more suitable to run the service that needs performance priority of hard disk I/O, especially to run the virtual machine of the database that needs high hard disk I/O request, than the partition with the cluster set configuration.

The energy saving partition P3 can perform energy-saving control energy control on the servers within the energy saving partition P3 based on an energy-saving strategy or rule. For example, in one embodiment, the energy-saving strategy may include gathering all of the virtual machines to be run on few servers within the energy saving partition P3 in a specified period of time (for example: when the evening) to save energy. Specifically, the resource allocator 406 may gather the virtual machines which have special performance requirement during the day or its performance or computing requirements during would be higher than in the evening, such as, virtual machines providing virtual machine backup services or virtual machines providing virtual desktop infrastructure (VDI) services, to be located in the energy saving partition P3 through the transfer processing, and based on a fixed time configured by the manager, automatically suspend or reduce the number of traffic and hard disk access for the servers with no virtual machine being operated to save energy. For example, the virtual machine running on the server in the energy saving partition P3 has a high operation resource during the day and low operation resource during the evening, so in the evening, the resource allocator 406 can automatically gather all of the virtual machines within the energy saving partition P3 to be run on few servers and forcing other servers within the energy saving partition P3 to enter hibernation mode to save power.

The abnormality analysis and determination device 404 may automatically determine, based on the definition data of resource setting and setting data of resource partitions in the database 408, such as using purpose of virtual machines and application type installed within the virtual machines, along with health states determined by the adjustment setting definition, whether any virtual machine is abnormal, and automatically determine the occurrence duration of the abnormal item, when an abnormal occurs and the repeat frequency and duration has exceeded than an expected value, it will automatically send trigger signal or open alarm notification.

The resource allocator 406 may then provide the aforementioned automatic processing based on the abnormal situation. Specifically, the resource allocator 406 may perform three processing mode based on abnormality determination results. The first processing is the limiting processing. In the case of a virtual machine suddenly abnormal, it may be caused by sudden attack that causes data processing traffic increases, immediately limiting the data traffic can protect other virtual machines to operate properly. In one embodiment, the resource allocator 406 may perform the above limitation on the same resource partition. The second processing is the transfer processing, which reallocates the partitions and select the appropriate server for the abnormal status occurred repeatedly, on the contrary, for the virtual machine does not meet the requirements for the partition, reallocates to appropriate partitions and reassigns to appropriate server. The third processing is the resource allocation, which can adjust resources of servers within the same partition.

In one embodiment, the resource allocator 406 may perform the limiting processing by limiting at least one resource of the virtual machine in performance abnormal status to be used and releasing the limiting of the use of the at least one resource of the virtual machine in performance abnormal status upon detecting the releasing of the abnormal status. In some embodiments, the resource allocator 406 may perform the limiting processing by adjusting the operation status data of the virtual machine in performance abnormal status from a first operation status data to a second operation status data and restoring the operation status data of the virtual machine to the first operation status data upon detecting the releasing of the abnormal status. By adjusting of the operation status data, restriction on the use of specific resources can be provided to the virtual machine in performance abnormal status to protect the server, so that it can run other virtual machines properly. For example, the resource allocator 406 can automatically determine the type of the virtual machine in performance abnormal status and the setting of resource partition where it locates, and if the virtual machine belongs to a machine with a traffic restriction capability, when an abnormal status occurs, performs the aforementioned limiting processing by setting the limiting of the using resources such as setting the upper and lower limits for the traffic to ensure that other virtual machines run on the same server will not be affected. By doing so, when the virtual machine running the internet services is attacked by network cyber and causes a lot amount of data processing traffic, the network traffic can be limited by resetting the TOPS and QoS settings and then waiting until a preset time has expired. If it is determined that the server is returned to normal, the IOPS and QoS settings is automatically returned to the original TOPS and QoS settings, thereby avoiding the vandalism or hacker attacks on the whole system.

In one embodiment, the resource allocator 406 may further determine which resource partition of the resource partitions is to be transferred first according to operation service type and resource requirement for the virtual machine in performance abnormal status when performing the transfer processing. For example, for the transfer processing, the resource allocator 406 may automatically determine to trigger the transfer mechanism when the virtual machine continually faces unexpected performance requirement occurrence. For example, when a virtual machine continually faces unexpected performance requirement occurrence such as CPU usage for the virtual machine lasting more than 80 percent, this virtual machine is determined as an abnormal virtual machine and thus the transfer processing is performed to ensure the transfer of operational performance. In addition, it also represents that the virtual machine has high computing needs, and the running service of the virtual machine is first determined to find that it is suitable for running on the high-availability partition P1 (i.e., the network traffic I/O first) or standard availability partition P2 (i.e., the hard disk I/O first). Then, the highest overall score of all of the servers with the partition is determined as the optimal server transfer according to the following calculation formula:

Item Score=weight of server resource*resource threshold*performance ratio;

Overall score=scores of CPU items+scores of memory items+scores of hard disk items+scores of network traffic item,

where the weight of server resource is a weight value determined in advance based on performance of each resource (hardware device) of server, the higher the performance of a resource, the higher the weight value. For example, taking the hard disk read and write performance as an example, SAS is better than SATA and SATA is better than IDE, and the network traffic for 10 Gbps bandwidth network interface card (NIC) can provide faster network sending and receiving traffic than the 1 Gbps and 100 Mbps bandwidth NICs so the weight of the SAS hard disk will be higher than that of the SATA. The resource threshold is a value for the abnormal resource in the virtual machine, such as virtual machine CPU usage is too high, so the transfer server should be able to provide better CPU performance when other remaining resources meet operational requirements. If the server is abnormal, then the value of its resource threshold is set to one. The performance ratio represents the operation performance of the server itself, which can be calculated by following formula:

$$1 + \frac{( \begin{matrix}The maximum value of the overall server performance - \\ Target server performance\end{matrix} )}{The maximum value of the overall server performance} .$$

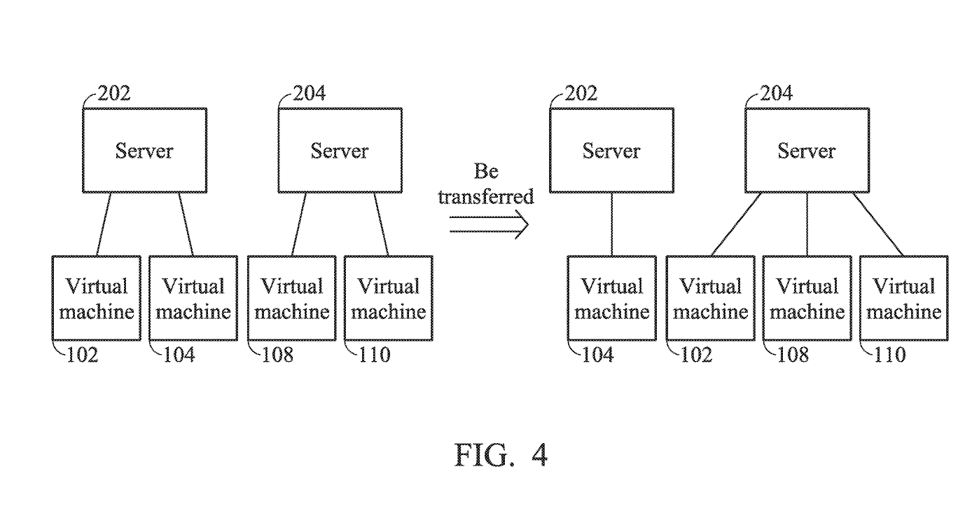

For example, assume that the CPU utilization of three servers were 60%, 70% and 80%, the performance ratio of the three servers are 1+(80−60)/80=1.25, 1+(80−70)/80=1.125, and 1+(80−80)/80=1, respectively. Thereafter, the resource allocator 406 may identify an optimal server from the remaining servers to be served as the transfer server based on the preceding formula calculation result and then transfer the virtual machine in performance abnormal status to the transfer the server for operation. Embodiment of the transfer processing will be discussed further with referring to FIG. 4.

FIG. 4 is a schematic diagram illustrating an embodiment of the transfer processing of the invention. As shown in FIG. 4, at initial, the virtual machines 102 and 104 are configured on the server 202 and the virtual machines 108 and 110 are configured on the server 204. Suppose the virtual machine CPU usage of the virtual machine 102 lasting more than 80% over a period of a predetermined time, the abnormality analysis and determination device 404 determines the virtual machine 102 is the virtual machine in performance abnormal status and issue the trigger signal, such that the resource allocator 406, in response to the abnormal item information included in the trigger signal, determines the transfer processing should be performed to ensure operational performance, and therefore finds a server suitable for transfer, i.e., the server 204 in this embodiment, according to the foregoing calculation formula, and transfers the virtual machine 102 to the server 204 for operation.

In one embodiment, the resource allocator 406 may further wait for a predetermined period of time after the virtual machine in performance abnormal status has transferred to the transfer server for operation, and after the predetermined period of time passes, the resource allocator 406 determines whether the abnormal situation of the virtual machine has been released. The resource allocator 406 may perform a network validation mechanism such as the validation of VLan, IP Ping and service port to determine whether the network is normal after transferring. In addition, in order to reduce the occurrence chance that another calculation will be performed to enabling another transferring to be occurred even if the performance has returned to normal after performing the transfer processing, which leads to unnecessary and pointless transfer operation in the environment and affects the overall performance between the servers, the resource allocator 406 may further wait for a waiting period, such as one hour, during which the processing is stopped after the predetermined period of time has expired. In this waiting period, performance monitoring is performed only and the predefined abnormal handling mechanisms will not be performed.

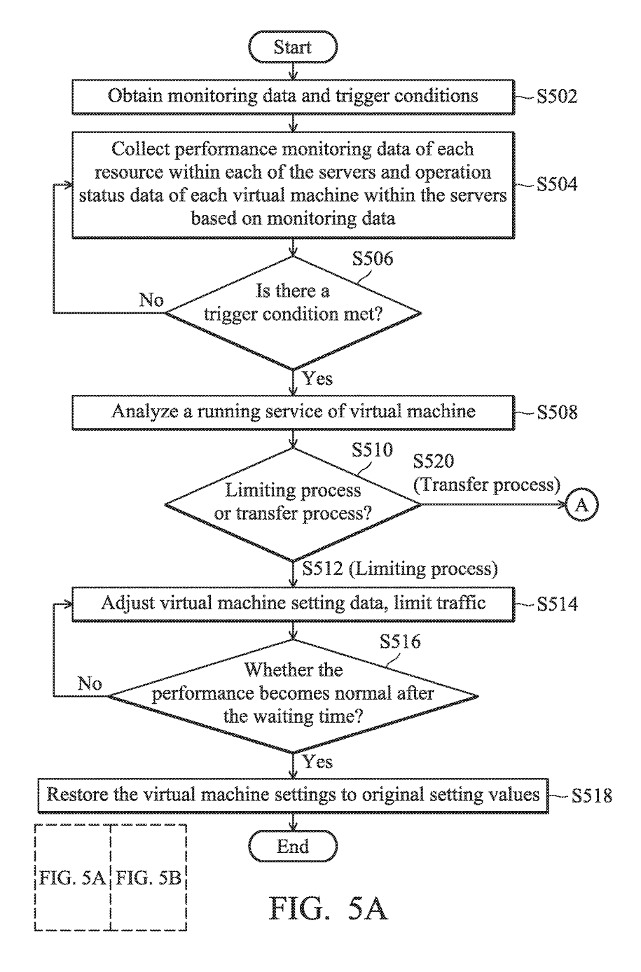

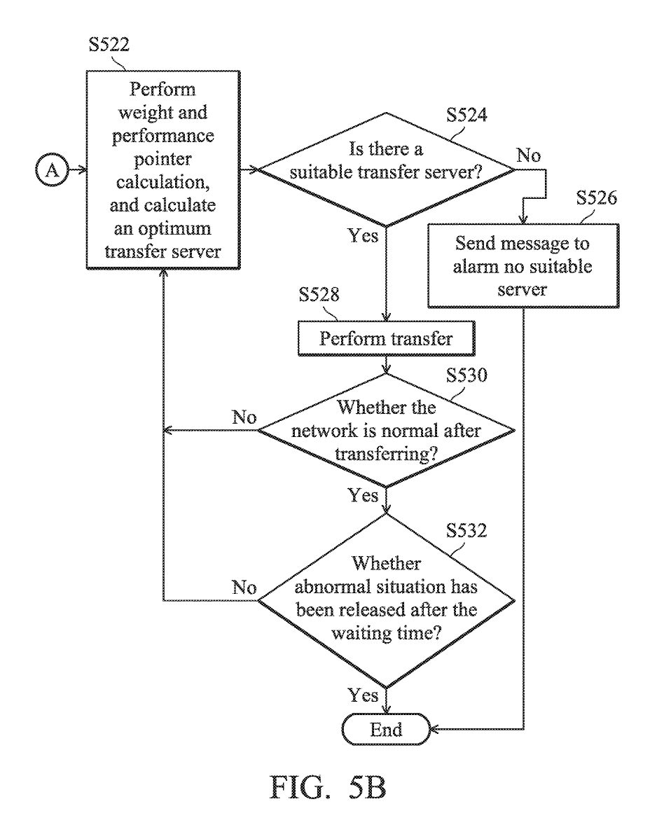

FIGS. 5A and 5B are flow charts illustrating a management method for management of resources of servers for use in the management system 10 according to another embodiment of the invention.

First, in step S502, the resource status monitor 402 and abnormality analysis and determination device 404 obtain monitoring data and trigger conditions from the database 148, respectively; then, in step S504, the resource status monitor 402 collects performance monitoring data of each resource within each of the servers and operation status data of each virtual machine within the servers based on items to be monitored indicated by the monitoring data; in step S506, the abnormality analysis and determination device 404 analyzes data collected by the resource status monitor 402 and compares those with the trigger condition obtained in step S502, and determines whether any trigger condition is met. If so, a trigger signal is sent and the flow proceeds to step S508; otherwise, the flow returns to step S504 to re-gather information and subsequent comparison.

In step S508, the resource allocator 406 readies for abnormal handling, which first determines the running service of the virtual machine in performance abnormal status to acquire its resource requirements, including partitioning information where the virtual machine in performance abnormal status is located, the type of the running service and so on. Then, in step S510, the resource allocator 406 determines whether the limiting processing or the transfer processing is to be performed according to the determination result or preset processing mechanism. When it is determined that the limiting processing as shown in step S512 is to be performed, the flow proceeds to steps S514 to S518. When it is determined that the transfer processing as shown in step S520 is to be performed, the flow proceeds to steps S522 to S532 as shown in FIG. 5B.

In the limiting processing flow of step S514, the resource allocator 406 adjusts the setting data of the virtual machine in performance abnormal status to set an upper limit and a lower limit of the resource currently being used, such as traffic, for example, adjusting TOPS or QoS setting data to limit network traffic; thereafter, in step S516, the resource allocator 406 waits for a predetermined waiting time, e.g., one hour, and after the waiting time passes, determines whether the performance of this virtual machine becomes normal. If so, the flow proceeds to step S518; otherwise, the flow returns to step S514 to continue to set the setting data of the virtual machine so as to re-set the network traffic.

In step S518, the resource allocator 406 determines that the performance of the virtual machine is returned to normal, indicating that an abnormal situation has been released, and thus restores the setting data of the virtual machine to its original setting value and releasing the traffic restriction, the flow ends. Thus, through setting the upper limit and the lower limit of the resource currently being used by the virtual machine, such as traffic, it ensures that the operations of other virtual machines running on the server will not be affected, thereby avoiding the vandalism or hacker attacks on the whole system.

As shown in FIG. 5B, first, in the transfer processing flow of step S522, the resource allocator 406 performs weight and performance pointer calculation based on aforementioned formulas and calculations to calculate an optimum transfer server. Next, in step S524, the resource allocator 406 if there is a suitable transfer server. If so, the flow proceeds to step S528 to ready for perform preceding transfer as shown in FIG. 4; if not, it proceeds to step S526 in which the resource allocator 406 sends messages or mails to alarm the supervisor that an abnormal occurs and no suitable server can be transferred to notice the supervisor to immediately perform subsequent processing.

In step S528, the resource allocator 406 performs the transfer processing to transfer the virtual machine in performance abnormal status to the optimum transfer server for operation. After the transferring between two servers is completed, then, in step S530, the resource allocator 406 performs a network validation mechanism such as the validation of VLan, IP Ping and service port to determine whether the network is normal after transferring. If so, the flow proceeds to step S532; otherwise, it returns to step S522 to re-calculate and determine another optimum transfer server among other remaining servers based on weight and performance pointer calculation and then perform subsequent transfer.

In step S532, the resource allocator 406 waits for a waiting period during which the processing is stopped, waiting for a predetermined waiting time, such as one hour. In this waiting period, performance monitoring is performed only and the predefined abnormal handling mechanisms will not be performed. After the waiting time passes, the resource allocator 406 determines whether the abnormal situation of the virtual machine has been released. If so, it means that the abnormal situation of the virtual machine is released after the transferring, the flow ends; if not, it means that the abnormal situation of the virtual machine is not released after the transferring, the flow returns to step S522 to re-calculate and determine another optimum transfer server among other remaining servers based on weight and performance pointer calculation and then perform subsequent transfer. By doing so, it can reduce the occurrence chance that another calculation will be performed to enabling another transferring to be occurred even if the performance has returned to normal after performing the transfer processing, which leads to unnecessary and pointless transfer operation in the environment.

In some embodiments, if the resource allocator 406 analyzes the obtained performance monitoring data and finds that the virtual machine operated in a low utilization period (e.g., computing needs during the day is higher than that during the night while the low utilization period is in the night), the resource allocator 406 may distribute this virtual machine to the energy saving partition. In the energy saving partition, the resource allocator 406 can automatically adjust the number of virtual machines operating on each server within the energy saving partition, such as gathering all of the virtual machines to be run on few servers and forcing the idle servers to enter hibernation mode during the low utilization period and then moving the virtual machines back to appropriate servers for operation during the high utilization period.

Therefore, according to the management systems and related methods for management of resources of servers of the present invention, a verity of data of servers and virtual machines can be automatically collected and abnormality determination can be performed based on preset trigger conditions such that when there is an abnormal situation, subsequent automated processing can be completed automatically in accordance with the running services of the virtual machines and virtual partitions along with the weights of resources being operated as the basis, thereby reducing human error to exclude or delay the time of processing and achieving a goal for effective management.

The embodiments of methods for providing black frame insertion that have been described, or certain aspects or portions thereof, may be practiced in logic circuits, or may take the form of program code (i.e., instructions) embodied in tangible media, such as floppy diskettes, CD-ROMS, hard drives, or any other machine-readable storage medium, wherein, when the program codes are loaded into and executed by a machine, such as a smartphone, a mobile phone, or a similar device, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, the machine becomes an apparatus for practicing the invention. When implemented on a general-purpose processor, the program codes combine with the processor to provide a unique apparatus that operate analogously to specific logic circuits.

Use of ordinal terms such as “first” and “second” in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. On the contrary, it is intended to cover various modifications and similar arrangements (as would be apparent to the skilled in the art). Therefore, the scope of the appended claims should be accorded the broadest interpretation so as to encompass all such modifications and similar arrangements.

What is claimed is:

1. A management method for management of resources of a plurality of servers, comprising:
collecting, by a resource status monitor, performance monitoring data of each resource within each of the servers and operation status data of a plurality of virtual machines within the servers;
analyzing, by an abnormality analysis and determination device, the performance monitoring data and the operation status data collected to automatically send a trigger signal in response to determining that a virtual machine in performance abnormal status is exist among the virtual machines; and
automatically performing, by a resource allocator, a processing on the virtual machine in performance abnormal status in response to the trigger signal, wherein the processing is at least one action of a limiting processing, a transfer processing and a resource allocation.

2. The management method of claim 1, wherein the resource allocator further generates a plurality of resource partitions based on weights and performance requirements of the resources and performs the processing according to resource partition information of the resource partition where the virtual machine in performance abnormal status locates.

3. The management method of claim 2, wherein the resource partition further comprises an energy-saving partition, the energy-saving partition including a plurality of control operation on virtual machines within the first servers based on an energy-saving strategy.

4. The management method of claim 2, wherein the resource allocator further performs the transfer processing by finding a transfer server from the servers and transferring the virtual machine in performance abnormal status to the transfer server for operation.

5. The management method of claim 4, wherein the resource allocator further determining which resource partition of the resource partitions is to be transferred first according to operation service type and resource requirement for the virtual machine in performance abnormal status when performing the transfer processing.

6. The management method of claim 2, wherein the resource allocator further performs the resource allocation by performing the resource allocation on the server where the virtual machine in performance abnormal status locates.

7. The management method of claim 2, wherein the resource allocator further performs the limiting processing by limiting at least one resource of the virtual machine in performance abnormal status to be used and releasing the limiting of the use of the at least one resource of the virtual machine in performance abnormal status upon detecting the releasing of the abnormal status.

8. The management method of claim 3, wherein the resource allocator further performs the limiting processing by adjusting the operation status data of the virtual machine in performance abnormal status from a first operation status data to a second operation status data and restoring the operation status data of the virtual machine to the first operation status data upon detecting the releasing of the abnormal status.

9. A management system for management of resources of servers, comprising:
a plurality of servers;
a plurality of virtual machines, wherein the virtual machines are separately configured on the servers; and
a management device coupled to the servers through a network, including:
a resource status monitor coupled to the servers for collecting performance monitoring data of each resource within each of the servers and operation status data of the virtual machines within the servers;
an abnormality analysis and determination device coupled to the resource status monitor for analyzing the performance monitoring data and the operation status data collected to determine whether a virtual machine in performance abnormal status is exist among the virtual machines and automatically send a trigger signal in response to determining that the virtual machine in performance abnormal status is exist; and
a resource allocator coupled to the abnormality analysis and determination device for automatically performing a processing on the virtual machine in performance abnormal status in response to the trigger signal,
wherein the processing is at least one action of a limiting processing, a transfer processing and a resource allocation.

10. The management system of claim 9, further comprising a database for storing information on abnormality determination rules for used by the abnormality analysis and determination device to determine whether the virtual machine in performance abnormal status is exist among the servers according to the performance monitoring data and the operation status data collected.
